(19) United States
(12) Patent Application Publication
(10) Pub. No.: US 2024/0198452 A1
(43) Pub. Date: Jun. 20, 2024

(54) METHOD FOR CHANGING THE POLARIZATION OF A LASER

(71) Applicant: TRUMPF Lasersystems for Semiconductor Manufacturing GmbH, Ditzingen (DE)

(72) Inventors: Morris Dahlinger, Murrhardt (DE); Kai Carstens, Kirchheim (DE)

(21) Appl. No.: 18/590,983

(22) Filed: Feb. 29, 2024

Related U.S. Application Data
(63) Continuation of application No. PCT/EP2021/074262, filed on Sep. 2, 2021.

(51) Int. Cl. B23K 26/064; G02B 5/30

(52) U.S. Cl. CPC B23K 26/064; G02B 5/3058

(57) ABSTRACT

A method for changing a polarization of a working laser beam includes generating the working laser beam in a working laser source, and irradiating a Verdet medium of a Faraday rotator using the working laser beam. The method further includes changing a charge carrier density of the Verdet medium by irradiating the Verdet medium using an excitation laser beam, and/or applying an electric field to the Verdet medium using an electrode, and/or changing a temperature of the Verdet medium using a heating element and/or a cooling element.

### CROSS REFERENCE TO RELATED APPLICATIONS

This application is a continuation of International Application No. PCT/EP2021/074262 (WO 2023/030633 A1), filed on Sep. 2, 2021, and claims benefit to International Application No. PCT/EP2021/074262, filed on Sep. 2, 2021. The aforementioned application is hereby incorporated by reference herein.

### FIELD

Embodiments of the present invention relate to a method for changing the polarization of a working laser beam.

### BACKGROUND

US2014/013 99 11 A1 relates to a Faraday rotator, in which a Faraday rotation of the polarization of electromagnetic radiation incident on the Faraday rotator is primarily generated by band transitions in a semiconductor material. The Faraday rotation remains virtually unchanged in a broad range of the infrared spectrum. The Faraday rotation is, however, dependent on local inhomogeneities of the semiconductor material.

### SUMMARY

Embodiments of the present invention provide a method for changing a polarization of a working laser beam. The method includes generating the working laser beam in a working laser source, and irradiating a Verdet medium of a Faraday rotator using the working laser beam. The method further includes changing a charge carrier density of the Verdet medium by irradiating the Verdet medium using an excitation laser beam, and/or applying an electric field to the Verdet medium using an electrode, and/or changing a temperature of the Verdet medium using a heating element and/or a cooling element.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a longitudinal section through a first embodiment of a device for changing the polarization of a working laser beam;

FIG. 2 schematically shows a cross section through the first embodiment of the device;

FIG. 3 schematically shows a longitudinal section through a second embodiment of the device;

FIG. 4 schematically shows a cross section through a third embodiment of the device;

FIG. 5 schematically shows a fourth embodiment of the device;

FIG. 6a schematically shows a cross section through an intensity profile of a working laser beam, wherein the beam axis of the working laser beam lies in the cross-sectional plane, according to some embodiments;

FIG. 6b schematically shows the profile of the working laser beam from FIG. 6a in a plane perpendicular to the beam axis of the working laser beam, according to some embodiments;

FIG. 6c schematically shows an annular profile of an excitation laser beam according to some embodiments;

FIG. 6d schematically shows the profile of the component of the working laser beam from FIG. 6b which passes through a polarizer, according to some embodiments;

FIG. 7 schematically shows a fifth embodiment of a device with a first laser beam of a working laser;

FIG. 8 schematically shows the fifth embodiment of the device with a second laser beam of the working laser and an excitation laser beam;

FIG. 9a schematically shows the alignment of a polarizer of a device and the polarization of a first laser beam before and after the reflection of the first laser beam on a Verdet medium of the device, according to some embodiments;

FIG. 9b schematically shows the alignment of a polarizer of the device and the polarization of a second laser beam before and after the reflection of the second laser beam on the Verdet medium of the device, according to some embodiments;

FIG. 9c schematically shows the alignment of a polarizer of the device and the polarization of the second laser beam before and after the reflection of the second laser beam on the Verdet medium of the device when the excitation laser beam is radiated onto the Verdet medium, according to some embodiments;

FIG. 10 schematically shows a sixth embodiment of the device;

FIG. 11 schematically shows a seventh embodiment of the device; and

FIG. 12 schematically shows a method for changing the polarization of a working laser beam according to some embodiments.

### DETAILED DESCRIPTION

Embodiments of the present invention provide a method for precisely and quickly changing the polarization of a working laser beam. Embodiments of the invention also provide a device for carrying out such a method.

According to embodiments of the invention, the method comprises the following method step/method steps:
A) generating a working laser beam in a working laser source;
C) irradiating a Verdet medium of a Faraday rotator using the working laser beam.
E) changing the charge carrier density of the Verdet medium by
irradiating the Verdet medium using an excitation laser beam; and/or
applying an electric field to the Verdet medium using an electrode; and/or
changing the temperature of the Verdet medium using a heating and/or cooling element.

The Verdet constant of a Verdet medium is dependent on the density of the free charge carriers in the Verdet medium, in general linearly. This charge carrier density can be changed in a manner limited in location and time by changing the temperature of the Verdet medium or by generating electric fields in the Verdet medium using laser beams or electrodes. The Verdet constant is thus deliberately set advantageously by local changes of the density of the free charge carriers. The Verdet constant can be spatially and/or chronologically modulated. A wavelength dependence of the Verdet constants is balanced out in the scope of the method in particular by the variation of the charge carrier density in the Verdet medium. In some embodiments, the method causes a homogeneous charge carrier density of the Verdet medium. This relates, inter alia, to embodiments in which the Verdet medium is formed as a material component of a thin wafer that can be easily cooled.

In the method, the lifetime and the diffusion length of the free charge carriers and the thermal conductivity of the Verdet medium are incorporated into the spatial and/or chronological change of the density of the free charge carriers of the Verdet medium. If an excitation laser is used, preferably having a wavelength of 3 μm to 4 μm, the intensity distribution of the laser beam, which determines the local charge carrier density, is set by beamforming of the excitation laser. The flank steepness and the wavelength of the excitation laser also determine the spatial and/or chronological change of the charge carrier density of the Verdet medium here. If electrodes are used as electrical contacts, preferably multiple electrodes for applying an electrical field, the dimensions of the contacts are important for this charge carrier density.

The working laser source is preferably designed in the form of a CO₂ laser source. Excitation laser sources for generating an excitation laser for changing the density of the free charge carriers in the Verdet medium have laser diodes which in particular emit an excitation laser beam having wavelengths of 3000 nm, 3370 nm and/or 3800 nm. Further possible excitation laser sources are a helium-neon laser, which preferably emits an excitation laser having a wavelength of 3392.2 nm, an infrared emitter, a super continuum laser, an Nd:YAG laser and/or micro-incandescent lamps, possibly having a bandpass filter.

A laser beam is understood in particular as an electromagnetic wave which characterizes the laser. The working laser beam is generally linearly polarized. A medium designates in particular a material wave carrier for the working laser. The term Verdet medium refers in particular to a medium permeated by a magnetic field, preferably parallel to a component of the propagation direction of the working laser. A Faraday effect is understood in particular as the rotation of a, preferably linearly, polarized electromagnetic wave in a medium permeated by a magnetic field, wherein the magnetic field preferably extends parallel to a directional component of the propagation direction of the electromagnetic wave and is preferably aligned parallel to the propagation direction of the electromagnetic wave. A Faraday rotator in particular has the Verdet medium and a magnet, the magnetic field of which permeates the Verdet medium and which is aligned suitably for generating a Faraday effect for changing the polarization of the working laser.

In one preferred embodiment of the method, the following method step is carried out after method step A):

B) conducting the working laser beam through a polarizer between working laser source and Verdet medium.

By using the polarizer, the polarization with which the working laser is incident on the Verdet medium can be defined. The polarizer between working laser source and Verdet medium is preferably linearly polarized.

In some embodiments of the method, the following method step is carried out after method step C):

D) conducting the working laser beam through a polarizer after the Verdet medium.

The polarizer after the Verdet medium is preferably linearly polarized. In particular, a first polarizer is connected upstream of the Verdet medium and a second polarizer is connected downstream of the Verdet medium. The polarization of the second polarizer is preferably rotated by 45° or by 90° in relation to the polarization of the first polarizer. The first polarizer and the second polarizer can form an optical isolator together with the Verdet medium.

In a further design of the method, a spatial and/or chronological change of the charge carrier density takes place in method step E) in at least one area of the Verdet medium. A first component of the working laser, which is reflected and/or transmitted by the area of the Verdet medium, has a different polarization and/or polarization alignment than a second component of the working laser, which is reflected and/or transmitted by the Verdet medium outside this area. The first component of the reflected and/or transmitted working laser can thus be handled differently than the second component. The area of the Verdet medium is in particular irradiated by the excitation laser in order to change the charge carrier density. Alternatively or additionally thereto, an electrode is attached to the area, which generates an electric field in particular with a different electrode, and/or a heating/cooling element is arranged at the area, and covers the area.

In a further variant of the method, the working laser beam has a first laser beam and a second laser beam following the first laser beam, wherein the second laser beam has a different wavelength and/or a different polarization than the first laser beam. Both laser beams are reflected and/or transmitted by the Verdet medium. This reflection and/or transmission takes place in separate areas of the Verdet medium and/or offset in time. With a suitable magnetic field, which permeates the Verdet medium, the first and the second laser beam have the same polarization after the reflection and/or transmission. In some variants of this design, the laser beams are blocked efficiently by only one polarizer, which is arranged in the beam path behind the Verdet medium, so that it does not cause undesired damage in the surroundings. Blocking is understood in particular to mean that the laser beams are not transmitted. Without the magnetic field, the first and/or the second laser beam pass the polarizer. The passage of the first and/or second laser beam through the polarizer can thus be switched on and switched off as needed.

A design of the method is preferred in which the following method step is carried out after method step E):

F) outputting the working laser beam to generate extreme ultraviolet light (EUV) radiation in an EUV-generating device.

In the Faraday rotator, the polarization of the output working laser can be changed, for example in order to switch on or switch off the generation of EUV radiation depending on the polarization of the output working laser with the aid of a polarizer.

The EUV-generating device preferably comprises a droplet generator for emitting tin droplets. The tin droplets are converted by the working laser beam into a plasma, which emits the EUV radiation. Radiation, in particular EUV radiation, which is backscattered in the direction of the Verdet medium, is preferably blocked here by a polarizer or an optical isolator which comprises the Verdet medium.

A device for changing the polarization of a working laser beam, in particular for carrying out a method according to any of the preceding designs, comprises the following features:
a) a working laser source for generating a working laser beam;
c) a Faraday rotator which can be irradiated using the working laser beam, wherein the Faraday rotator comprises a Verdet medium,
wherein the device is characterized in that it comprises the following feature/features:
e) to change the charge carrier density of the Verdet medium:
an excitation laser source for irradiating the Verdet medium using an excitation laser beam;
an electrode for applying an electric field to the Verdet medium; and/or
a heating and/or cooling element for changing the temperature of the Verdet medium.

In particular, the charge carrier density of the free charge carriers in the Verdet medium can be changed in a manner limited in location and/or time by the device. The Verdet constant of the Verdet medium can thus be deliberately set in order to cause a desired polarization of the working laser after the reflection and/or transmission by the Verdet medium.

One refinement of the device provides a first polarizer, which is arranged in the beam path of the working laser before or after the Faraday rotator. In this way, the polarization of the component of the working laser beam, which is emitted from the system made up of the polarizer and the Verdet medium, can be set according to a specification. In particular, only a component of the working laser having a specified polarization is incident on the Verdet medium through the polarizer. Alternatively, after the reflection and/or transmission through the Verdet medium, only a component of the working laser having the specified polarization passes through the polarizer.

One design of the above-mentioned refinement of the device is characterized by a second polarizer, which forms an optical isolator together with the first polarizer and the Faraday rotator, wherein the first polarizer is arranged in the beam path of the working laser beam before the Faraday rotator and the second polarizer is arranged after the Faraday rotator. By way of a suitable alignment of the polarizers, in particular an alignment of the polarizers at a 45° angle relative to one another, and a suitable selection of the magnetic field which permeates the Verdet medium, laser beams are let through only in the propagation direction of the working laser beam through the optical isolator, but not in the opposite direction. Inter alia, the working laser source is thus protected.

One preferred embodiment of the device is characterized by an EUV-generating device, which is arranged in the beam direction of the working laser beam after the Faraday rotator. The EUV-generating device in particular comprises a tin droplet source, from which tin droplets are emitted. The component of the working laser reflected and/or transmitted by the Verdet medium is incident on the tin droplets, wherein a plasma arises that emits EUV radiation. In embodiments in which the EUV-generating device is arranged in the beam path of the working laser after an optical isolator, which comprises the Faraday rotator, the optical isolator prevents a part of the radiation, in particular the EUV radiation, from being reflected by the tin droplets and radiating back into the working laser source.

One embodiment of the device is characterized in that the working laser source is designed to emit a first laser beam and a second laser beam following the first laser beam, wherein the second laser beam has a different wavelength and/or a different polarization than the first laser beam. With a suitable adaptation of the Verdet constants, the Verdet medium causes the first laser beam and the second laser beam to have the same polarization after the reflection and/or transmission by the Verdet medium. In this way, both laser beams can be blocked by only one polarizer in order to protect the surroundings of the device from the working laser beam.

According to embodiments of the invention, the features mentioned above and those explained in further detail may respectively be used individually or together in any desired combinations. The embodiments shown and described should not be understood as an exhaustive list, but rather are of exemplary character for describing the invention.

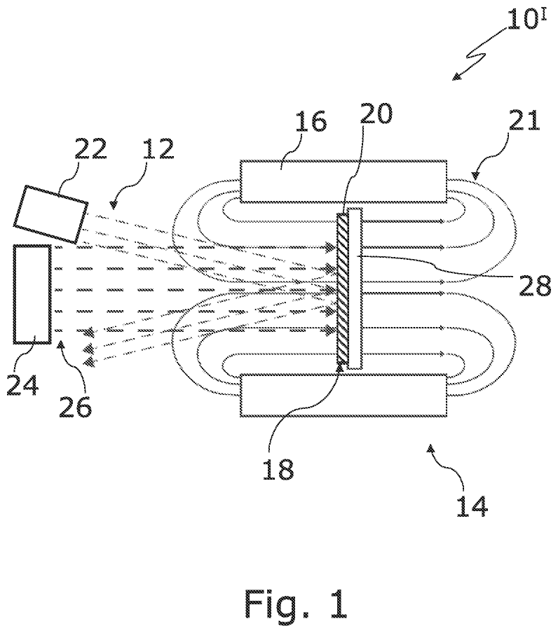

FIG. 1 schematically shows a longitudinal section through a first embodiment of a device 10^{I} for changing the polarization of a working laser beam 12. The device 10^{I} has a Faraday rotator 14. The Faraday rotator 14 is equipped with a permanent magnet 16, which surrounds a wafer 18 in its circumferential direction. The wafer 18 has a Verdet medium 20, i.e. a material wave carrier for the working laser beam 12, which is permeated by the magnetic field 21 of the permanent magnet 16. A working laser source 22 emits the working laser beam 12 which is radiated diagonally onto the wafer 18 and is reflected, wherein the working laser beam 12, in particular after a penetration of the working laser beam 12 into the wafer 18 and the Verdet medium 20 on an entry side, is reflected on a rear side of the wafer 18, which is opposite to the entry side. In addition, the device 10^{I} has an excitation laser source 24, from which an excitation laser beam 26 is radiated onto the wafer 18, wherein the propagation direction of the excitation laser beam 26 is preferably perpendicular to the surface of the wafer 18, on which the excitation laser beam is incident. The excitation laser beam 26 changes the density of the free charge carriers in the Verdet medium 20 and thus the Verdet constant of the Verdet medium 20. This causes a change of the polarization of the working laser beam 12 reflected from the Verdet medium 20 in comparison to the case where no excitation laser beam 26 is radiated onto the Verdet medium 20. A cooling element 28, in particular a diamond cooler, for cooling the wafer 18 is arranged on the wafer 18 having the Verdet medium.

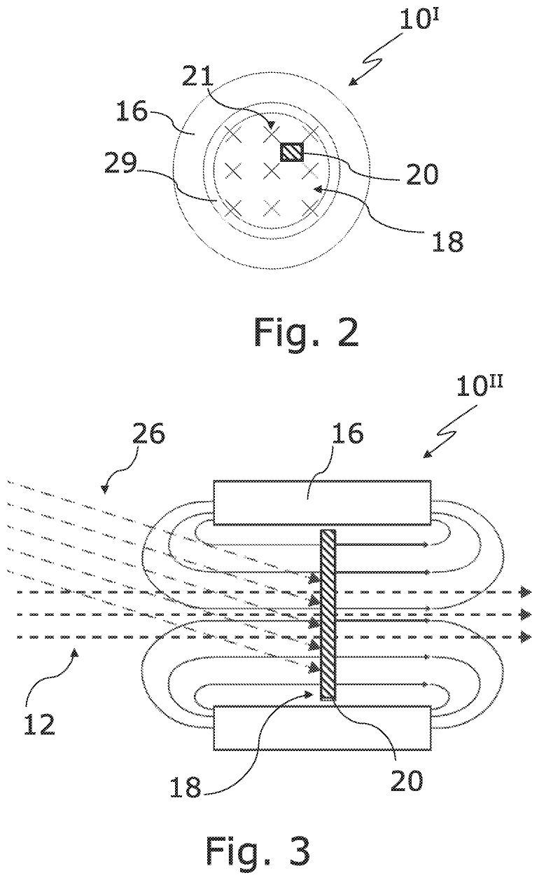

FIG. 2 schematically shows a cross section through the first embodiment of the device 10^{I} for changing the polarization of a working laser beam 12 (see FIG. 1). The permanent magnet 16 is shown, which annularly surrounds the wafer 18 having the Verdet medium 20 (schematically indicated by a shaded box), which is permeated by the magnetic field 21 of the permanent magnet 16, in the circumferential direction of the wafer 18, wherein a gap 29 is formed between the permanent magnet 16 and the wafer 18.

FIG. 3 schematically shows a longitudinal section through a second embodiment of the device 10^{II} for changing the polarization of the working laser beam 12. In contrast to the first embodiment, no cooling element 28 (see FIG. 1) is arranged on the wafer 18, surrounded by the permanent magnet 16, having the Verdet medium 20. The Verdet medium 20 is designed in the second embodiment of the device 10^{II} to transmit the working laser beam 12. The excitation laser beam 26 is radiated diagonally onto the wafer 18, whereas the propagation direction of the working laser beam 12 is perpendicular to the surface of the wafer 18, on which the working laser beam 12 is incident.

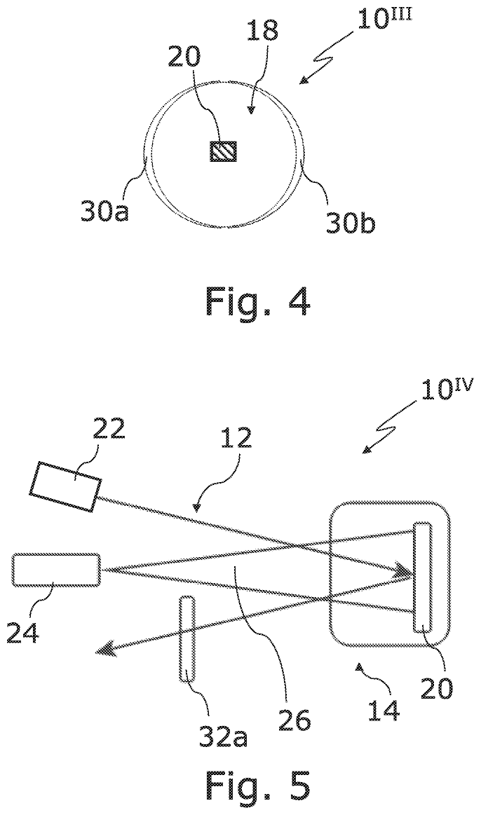

FIG. 4 schematically shows a cross section through a third embodiment of the device 10^{III} for changing the polarization of the working laser beam 12 (see FIG. 1). Electrodes 30a, 30b for generating electrical fields surround the wafer 18 in order to thus change the charge carrier density in the Verdet medium 20 (indicated by a shaded box) of the wafer 18, in particular the charge density in the entire wafer 18.

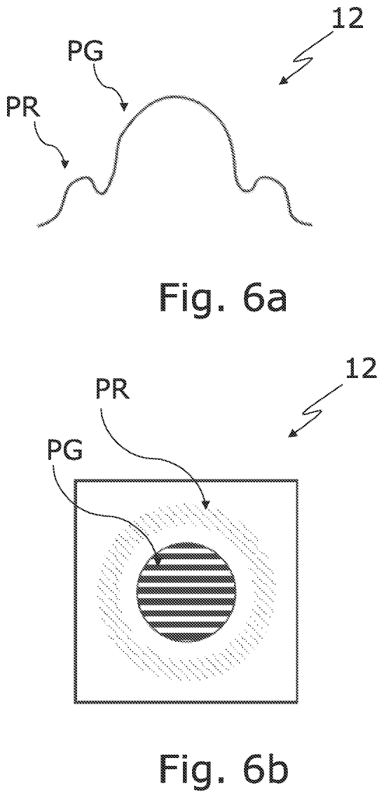

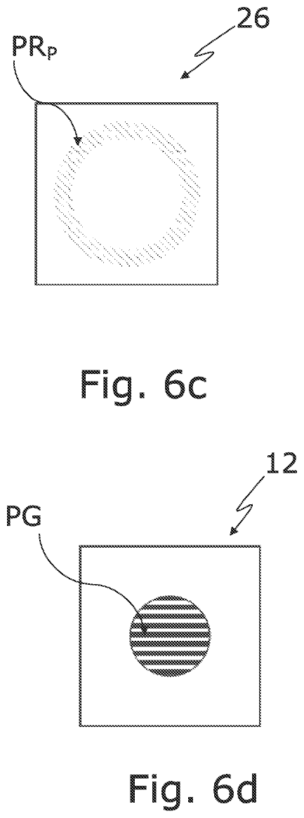

FIG. 5 schematically shows a fourth embodiment of the device 10^{IV} for changing the polarization of the working laser beam 12. The device 10^{IV} has a Faraday rotator 14 as in the first embodiment. From the working laser source 22, a working laser beam 12 is radiated diagonally onto the Verdet medium 20 of the Faraday rotator 14 and reflected thereby. A polarizer 32a is arranged in the beam path of the working laser beam 12 after the Faraday rotator 14. An excitation laser source 24 radiates an excitation laser beam 26 onto the Verdet medium 20, in particular with an annular profile (see FIG. 6c). The working laser beam 12 is polarized differently upon reflection on the Verdet medium 20 in an area of the Verdet medium 20 which is irradiated by the excitation laser beam 26 than in an area which is not irradiated by the excitation laser beam 26.

FIG. 6a schematically shows a cross section through an intensity profile of a working laser beam 12, which is emitted from a working laser source 22 (see FIG. 5) of a device 10 according to the fourth embodiment, wherein the beam axis of the working laser beam 12 lies in the cross-sectional plane. The intensity profile of the working laser beam 12 is composed of an overlaid Gaussian profile PG and an annular profile PR.

FIG. 6b schematically shows the profile of the working laser beam 12 in a cross-sectional plane perpendicular to the beam axis of the working laser beam 12 having the schematically indicated Gaussian profile PG and annular profile PR.

FIG. 6c schematically shows an annular profile PRₚ of the excitation laser beam 26 in a cross-sectional plane perpendicular to the beam axis of the excitation laser beam 26 (see FIG. 5). The Verdet constant of the Verdet medium 20 (see FIG. 5) is changed in an annular area in which the excitation laser beam 26 having the annular profile PRₚ is incident on the Verdet medium 20. The polarization of the working laser beam 12 thus also changes, which is reflected in this area by the Verdet medium 20, in relation to the polarization of the working laser beam 12 reflected from the Verdet medium 20 outside this area. The polarizer 32a (see FIG. 5) is suitably aligned to block the component of the working laser beam 12 which was reflected in the annular area of the Verdet medium 20 irradiated by the excitation laser 26. In particular, the polarizer 32a is aligned perpendicularly to the polarization of the component of the working laser beam 12 reflected in this annular area of the Verdet medium 20. The component of the working laser beam 12 which was reflected in this annular area of the Verdet medium 20 is thus blocked by the polarizer 32a.

FIG. 6d schematically shows the profile of the component of the working laser beam 12 which passes through the polarizer 32a in a cross-sectional plane perpendicular to the beam axis of this component of the working laser beam 12. The profile only has the Gaussian mode PG, but no longer an annular superimposed mode PR (see FIG. 6a).

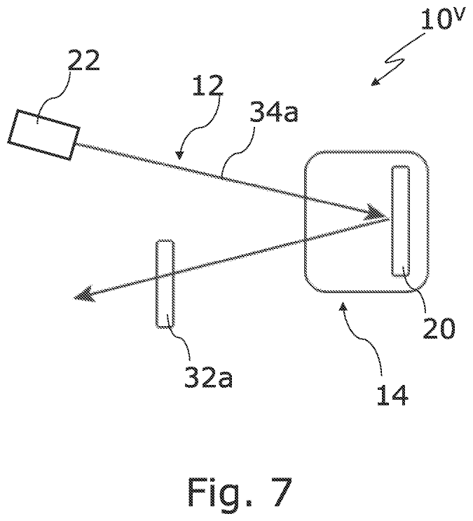

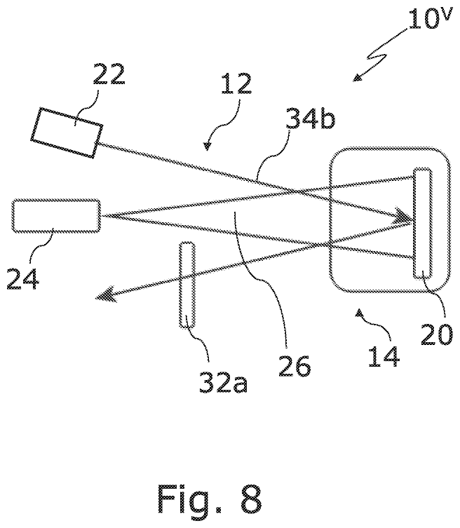

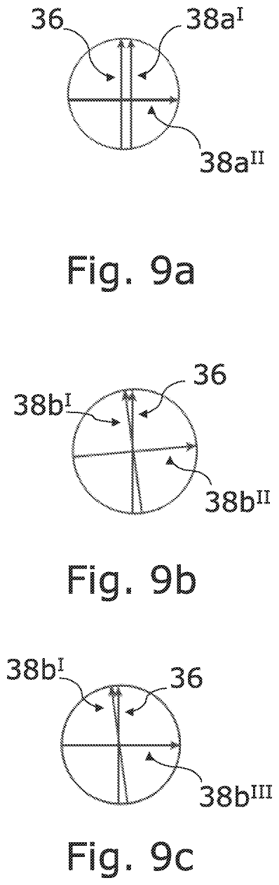

FIG. 7 schematically shows a fifth embodiment of the device 10^{V} for changing the polarization of the working laser beam 12, wherein the device 10^{V} has the Faraday rotator 14 having the Verdet medium 20 as in the fourth embodiment. In contrast to the fourth embodiment of the device 101^{V}, the working laser source 22 is designed to emit a working laser beam 12, which has a first laser beam 34a, which is in particular linearly polarized, in a first time interval, and a second laser beam 34b (see FIG. 8), which has a different wavelength and/or polarization than the first laser beam 34b, in a second time interval, which follows the first time interval. The polarizer 32a is aligned such that it blocks the first laser beam 34a (cf. FIG. 9a).

FIG. 8 schematically shows the fifth embodiment of the device 10^{V} for changing the polarization of a working laser beam 12, wherein the working laser beam 12 has the second laser beam 34b in the second time interval after the first time interval. The Verdet medium 20 therefore reflects the second laser beam 34b with a different polarization than the first laser beam 34a (see FIG. 7) if the Verdet constant of the Verdet medium 20 is the same as in the first time interval. Due to the irradiation of the excitation laser 26 from the excitation laser source 24, with a change of the Verdet constants, the polarization of the second laser beam 34b after the reflection is aligned identically by the Faraday effect as the polarization of the first laser beam 34a. The second laser beam 34b is then blocked, like the first laser beam, by the polarizer 32a.

FIG. 9a schematically shows the alignment 36 of the polarizer 32a and the polarization 38a^{I}, 38a^{II} of the first laser beam 34a before and after the reflection of the first laser beam 34a on the Verdet medium 20 (see FIG. 7). The alignment 36 of the polarizer 32a is perpendicular to the polarization 38a^{II} of the first laser beam 34a after the reflection on the Verdet medium 20, such that the first laser beam 34a is blocked by the polarizer 32a.

FIG. 9b schematically shows the alignment 36 of the polarizer 32a and the polarization 38b^{I}, 38b^{II} of the second laser beam 34b before and after the reflection of the second laser beam 34b on the Verdet medium 20 (see FIG. 7), wherein no excitation laser beam 26 (see FIG. 8) is radiated onto the Verdet medium 20. The polarization 38b^{II} of the second laser beam 34b after the reflection on the Verdet medium 20 is not perpendicular to the alignment 36 of the polarizer 32a, and so a part of the second laser beam 34b is transmitted through the polarizer 32a.

FIG. 9c schematically shows the alignment 36 of the polarizer 32a and the polarization 38b^{I}, 38b^{III} of the second laser beam 34b before and after the reflection of the second laser beam 34b on the Verdet medium 20 (see FIG. 7), wherein the excitation laser beam 26 (see FIG. 8) is radiated onto the Verdet medium 20, such that after reflection on the Verdet medium 20, the polarization 38b^{III} of the second laser beam 34b is aligned identically as the polarization 38a^{II} of the first laser beam 34a after this reflection (see FIG. 9a). The polarization 38b^{III} of the second laser beam 34b is therefore also perpendicular to the alignment 36 of the polarizer 32b, such that the second laser beam 34b is also blocked by the polarizer 32a.

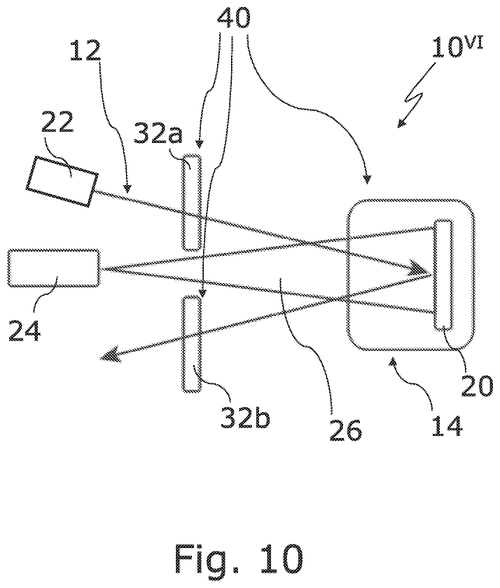

FIG. 10 schematically shows a sixth embodiment of the device 10^{VI} having the Faraday rotator 14 for changing the polarization of a working laser beam 12. The working laser beam 12 from the working laser source 22 is transmitted through a first polarizer 32a and a second polarizer 32b. In the beam path of the working laser beam 12, the first polarizer 32a is arranged before the Faraday rotator 14 and the second polarizer 32b is arranged after the Faraday rotator 14. The first polarizer 32a, the second polarizer 32b, and the Faraday rotator 14 together form an optical isolator 40. The Verdet medium 20 of the Faraday rotator 14 is irradiated here by the excitation laser beam 26 from the excitation laser source 24. The working laser beam 12 passes with a polarization determined by the first polarizer 32a through the first polarizer 32a. The working laser beam 12 is then reflected on the Verdet medium 20, in particular after at least partially penetrating into the Verdet medium 20, wherein the polarization is rotated by the Faraday effect. Depending on the polarization after the reflection, the working laser beam 12 passes through the second polarizer 32b or is entirely or partially blocked by the second polarizer 32b. Accordingly, a component of the working laser beam (not shown) backscattered from an object, which passes through the second polarizer 32b with a polarization determined by the second polarizer 32b and is then reflected on the Verdet medium 20 with rotation of its polarization, is entirely or partially blocked by the first polarizer 32a. In general, a working laser beam 12 can thus pass through the optical isolator 40, wherein laser light is blocked which is backscattered by an object (not shown), which is located in the beam path of the working laser beam after the second polarizer 32b, in order to protect the working laser source 22.

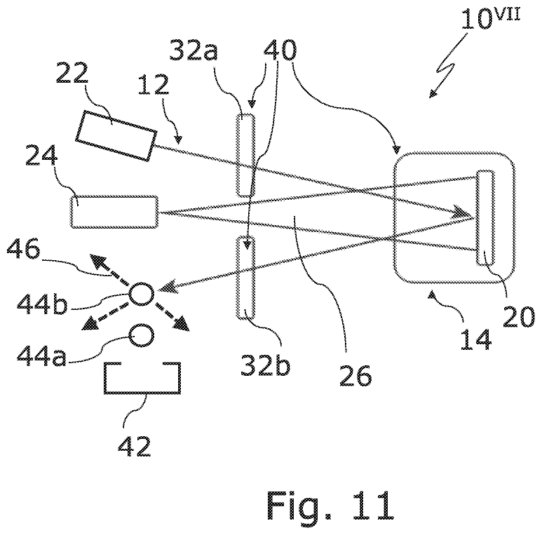

FIG. 11 schematically shows a seventh embodiment of the device 10^{VII} for changing the polarization of the working laser beam 12. In addition to the working laser source 22 for generating the working laser beam 12, the excitation laser source 24 for generating the excitation laser beam 26, the first and the second polarizer 32a, 32b and the Faraday rotator 14 having the Verdet medium 20, the device 10^{VII} in the seventh embodiment has an EUV-generating device 42 for generating extreme ultraviolet light (EUV) radiation. The EUV-generating device 42 emits tin droplets 44a, 44b, which are irradiated by the working laser beam 12 after passage through the second polarizer 32b. A plasma is generated, which emits (EUV) radiation 46. The working laser source 22 is isolated and protected by the optical isolator 40, having the polarizers 32a, 32b and the Faraday rotator 14, from a component of the radiation of the working laser beam 12, which is reflected by the tin droplets 44a, 44b, in that this component of the radiation is blocked by the optical isolator 40.

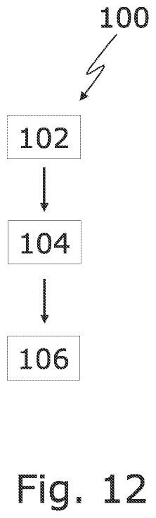

FIG. 12 schematically shows a method 100 for changing the polarization of a working laser beam 12 (see FIG. 11). In a first step 102, the working laser beam 12 is generated in a working laser source 22 (see FIG. 11). In a second step 104, a Verdet medium 20 (see FIG. 11) of a Faraday rotator 14 (see FIG. 11) is irradiated using the working laser beam 12. The polarization of the working laser beam 12 is rotated by the Verdet medium 20. In a third step 106, the density of the free charge carriers of the Verdet medium 20 is changed to adapt the Verdet constants of the Verdet medium 20 by one or more of the following measures:
irradiating the Verdet medium 20 using an excitation laser beam 26 (see FIG. 11); and/or
applying an electric field to the Verdet medium 20 using an electrode 30a, 30b (see FIG. 4); and/or
changing the temperature of the Verdet medium 20 using a heating and/or cooling element 28 (see FIG. 1).

Embodiments of the invention relate to a method 100 for changing the polarization of a working laser beam 12. The working laser 12 radiates out of a working laser source 22 onto a Faraday rotator 14. The Faraday rotator 14 has a Verdet medium 20 and a magnet 16, the magnetic field of which permeates the Verdet medium 20. The method 100 is characterized in that the density of the free charge carriers in the Verdet medium 20 and thus the Verdet constant of the Verdet medium 20 is changed. For this purpose, an electric field and/or a temperature change is caused in the Verdet medium 20 by an excitation laser beam 26 directed onto the Verdet medium 20, an electrode 30a, 30b arranged on the Verdet medium 20 and/or a heating/cooling element 28 arranged on the Verdet medium 20.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10^{I-VII} device for changing the polarization of a laser beam
12 working laser beam
14 Faraday rotator
16 permanent magnet
18 wafer
20 Verdet medium
22 working laser source
24 excitation laser source
26 excitation laser beam
28 cooling element
29 gap
30a,b electrodes
32a,b polarizers
34a,b first, second laser beam
36 alignment of the polarizer 32a
38a^{I-II} polarization of the first laser beam
38b^{I-III} polarization of the second laser beam
40 optical isolator
42 EUV-generating device
44a,b tin droplets
46 EUV radiation
PR annular profile of the working laser
PG Gaussian profile of the working laser
PR_{P} annular profile of the excitation laser

1. A method for changing a polarization of a working laser beam, the method comprising:
A) generating the working laser beam in a working laser source;
C) irradiating a Verdet medium of a Faraday rotator using the working laser beam; and
E) changing a charge carrier density of the Verdet medium by
irradiating the Verdet medium using an excitation laser beam; and/or
applying an electric field to the Verdet medium using an electrode; and/or
changing a temperature of the Verdet medium using a heating element and/or a cooling element.

2. The method as claimed in claim 1, further comprising, after step A):
B) passing the working laser beam through a polarizer between the working laser source and the Verdet medium.

3. The method as claimed in claim 1, further comprising, after step C):
D) passing the working laser beam through a polarizer after the Verdet medium.

4. The method as claimed in claim 1, wherein in step E), a spatial and/or chronological change of the charge carrier density takes place in at least one area of the Verdet medium.

5. The method as claimed in claim 1, wherein the working laser beam has a first laser beam and a second laser beam following the first laser beam, wherein the second laser beam has a different wavelength and/or a different polarization than the first laser beam.

6. The method as claimed in claim 1, further comprising, after step E):
F) outputting the working laser beam to generate extreme ultraviolet light radiation in an EUV-generating device.

7. A device for changing a polarization of a working laser beam, for carrying out a method as claimed in claim 1, the device comprising:
a) the working laser source for generating the working laser beam;
c) the Faraday rotator capable of being irradiated using the working laser beam, wherein the Faraday rotator has the Verdet medium; and
e) at least one of following for changing the charge carrier density of the Verdet medium:
an excitation laser source for generating the excitation laser beam for irradiating the Verdet medium; and/or
an electrode for applying the electric field to the Verdet medium; and/or
the heating element and/or the cooling element for changing the temperature of the Verdet medium.

8. The device as claimed in claim 7, further comprising a first polarizer arranged in a beam path of the working laser beam before or after the Faraday rotator.

9. The device as claimed in claim 8, further comprising a second polarizer, which forms an optical isolator together with the first polarizer and the Faraday rotator, wherein the first polarizer is arranged in the beam path of the working laser beam before the Faraday rotator and the second polarizer is arranged in the beam path after the Faraday rotator.

10. The device as claimed in claim 7, further comprising an EUV-generating device arranged in a beam direction of the working laser beam after the Faraday rotator.

11. The device as claimed in claim 7, wherein the working laser source is configured to emit a first laser beam and a second laser beam following the first laser beam, wherein the second laser beam has a different wavelength and/or a different polarization than the first laser beam.
